(19) United States
(12) Patent Application Publication
(10) Pub. No.: US 2015/0368015 A1
(43) Pub. Date: Dec. 24, 2015

(54) CABLE-TIE GUIDE

(71) Applicant: Stoneridge, Inc., Warren, OH (US)

(72) Inventor: Robert J. Steinman, Lexington, OH (US)

(21) Appl. No.: 14/743,307

(22) Filed: Jun. 18, 2015

Related U.S. Application Data
(60) Provisional application No. 62/013,800, filed on Jun. 18, 2014.

(51) Int. Cl. B65D 63/10; B01D 35/30

(52) U.S. Cl. CPC B65D 63/1027; B01D 35/30; B65D 2563/101

(57) ABSTRACT

Cable-tie guides are disclosed. In some embodiments the cable-tie guides include a head guiding member and a tape guiding member. The head guiding member may include a head opening that is configured to permit passage of a tape section of a cable-tie and to prevent passage of a head section of the cable-tie. The tape guiding member may include first and second tape openings and a recessed region there between. The recessed region may be defined by at least one sidewall, which may provide a tapered transition between the second and first tape openings.

### CROSS-REFERENCE TO RELATED APPLICATIONS

The present application claims the benefit of provisional application No. 62/013,800, filed Jun. 18, 2014, the entire content of which is incorporated herein by reference.

### FIELD

The present disclosure relates generally to cable-tie guides, and more particularly to cable-tie guides which may be integrated into various articles.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 is a perspective view of a cable-tie guide consistent with the present disclosure;

FIG. 2 is a cross-sectional view of a cable-tie guide consistent with the present disclosure;

FIG. 3 is a plan view of a cable-tie guide integrated with another component, consistent with the present disclosure; and

FIG. 4 is a perspective view of a cable-tie guide integrated with a filter holder consistent with the present disclosure.

### DETAILED DESCRIPTION

A cable-tie, also known as a zip-tie, is a type of fastener that generally includes an elongated tape section that includes first and second ends. A head section including a slot with a flexible pawl is generally formed at the first end of the tape section. The second end of the tape section is generally sized and configured into a “tip” which is capable of being threaded through the slot in the head section. As the tip is threaded through the slot the head section at least a portion of the tape section may be drawn past the flexible pawl, during which time the flexible pawl may engage an angled surface of one or more of a plurality of angled engagement members (“teeth”) formed between the first and second ends of the tape section. The flexible pawl may further engage the back side of one or more of the teeth, thereby substantially preventing removal of the tape section from the head section. The resulting loop formed by the head section and tape section may be cinched down by further threading the tape section through the head section, tightening around and eventually securing an object disposed within the loop.

While cable-ties have been proven useful for myriad fastening applications, the use of cable-ties in mass manufacturing (e.g., “assembly line”) processes has often been resisted. Due to their flexible nature, the head section of a cable-tie may move as a worker attempts to thread the tip of the cable-tie through the slot in the head section. As a result, workers may have difficulty installing cable-ties quickly without visually aligning the tip of a cable-tie with its corresponding head section.

With the foregoing in mind, the present disclosure generally relates to cable-tie guides. As will become apparent from the following description, use of a cable-tie guide consistent with the present disclosure may enable rapid alignment of the head and tape sections of a cable-tie, while limiting or eliminating the need for visual alignment of such sections. This may make cable-tie fasteners more attractive for use in a variety of manufacturing processes, and in particular high speed mass manufacturing processes in which visual alignment of the head and tail sections of a cable-tie may be difficult or may reduce manufacturing speed.

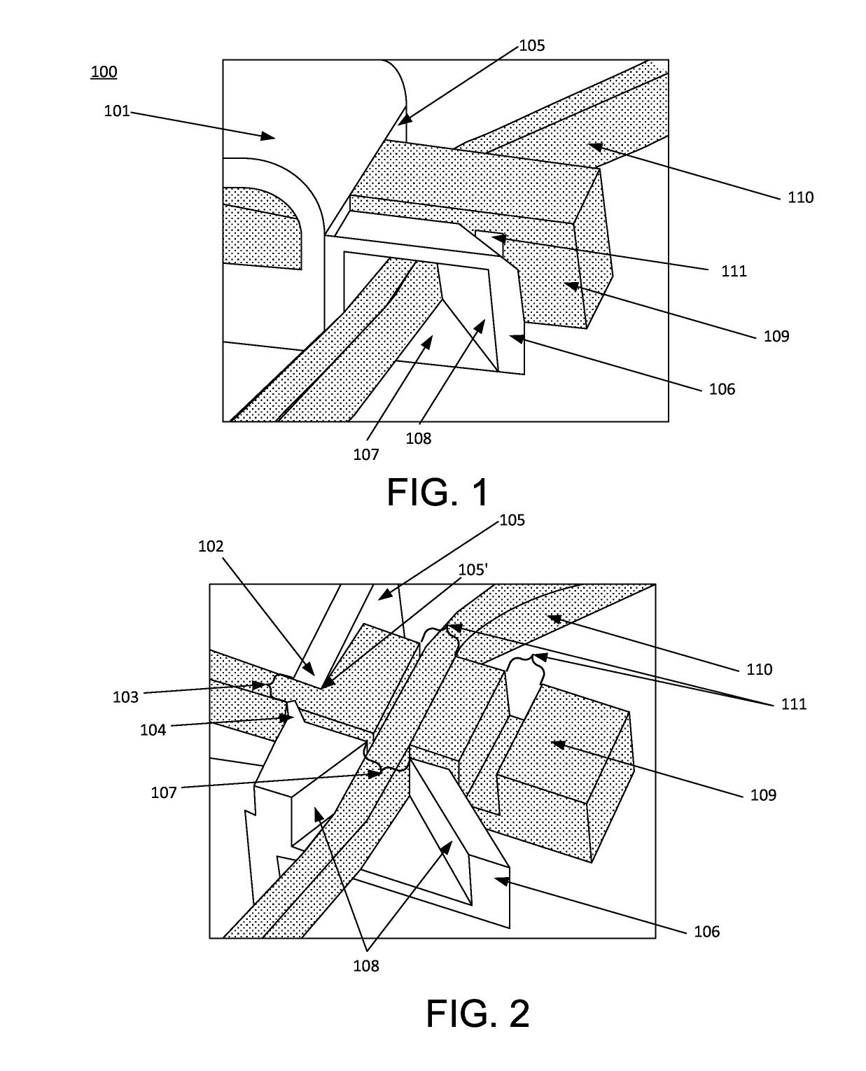

FIGS. 1 and 2 respectively provide a perspective view and a cross sectional view of cable-tie guide consistent with the present disclosure. Generally, a cable-tie guide 100 may be used to assist in the alignment of the head and tape sections of a cable-tie, e.g., during a manual or automatic manufacturing process. As illustrated in FIGS. 1 and 2, cable-tie guide 100 includes guide body 101. Guide body 101 may be manufactured from any suitable material, including but not limited to polymers, plastics, rubber, metal, etc., as desired. Without limitation, guide body 101 is preferably formed from a polymeric or plastic material, such as but not limited to polyamides (e.g., nylon).

In the illustrated embodiment guide body 101 includes a head guide member 102 and tape guide member 106. Head guide member 102 includes at least one head opening 103, which may be sized and configured to permit tape section 110 of a cable-tie (not separately labeled) to be threaded there-through, but to prevent passage of head section 109 of the cable-tie. Pulling the length of tape section 110 through head opening 103 may cause head section 109 to snugly abut against sidewall 105 of guide body 101, e.g., at shoulder region 105′.

In some embodiments, head opening 103 has a profile that matches or substantially matches a cross sectional profile of tape section 110 of a cable-tie. By way of example, where tape section 110 has a rectangular cross-sectional profile (e.g., as illustrated in FIGS. 1 and 2), head opening 103 may have a rectangular or substantially rectangular profile sized to permit (e.g., snug) passage of tape section 110 there-through. Of course such a profile is for the sake of example only, and head opening 103 may have any suitable geometry.

In some embodiments, head opening 103 is defined by first and second substantially parallel sides that are oriented substantially perpendicular to a horizontal axis, and which connect with substantially parallel top and bottom portions that are oriented substantially parallel with the horizontal axis. In such instances the length of the first and second parallel sides may be greater than that of either or both the parallel top and bottom portions. When configured in this manner, a tape section 110 having a substantially rectangular cross sectional profile may be inserted into head opening 103, such that a long dimension of the rectangular cross section of the tape section 110 is oriented substantially parallel with a long dimension of the profile of head opening 103, as generally shown in FIG. 2.

In additional non-limiting embodiments, head opening 103 may be configured such that when the length of tape section 110 is pulled there-through, a slot 111 in head section 110 of the cable-tie is aligned with tape opening 107 formed in tape guide member 106, the configuration of which will be described later. This concept is illustrated in FIGS. 1 and 2, which illustrate an embodiment in which tape opening 107 is aligned with slot 111 of a cable-tie when tape section 110 is drawn through head opening 102 so as to cause head section 109 to abut or substantially abut sidewall 105 of guide body 101.

As further illustrated in FIG. 2, head opening 103 may in some embodiments include retaining member 104. Retaining member 104 is generally configured to limit or prevent reverse translation (i.e., back out) of tape section 110 once at least a portion of tape section has been drawn through head opening 103. In FIG. 2, retaining member 104 is illustrated in the form of a pawl that may engage the back side of one or more of a plurality of engagement members (e.g., teeth, not shown) that may be formed on one or more sides of tape section 110. This embodiment is of course for the sake of example only, and retaining member 104 may have any configuration that is suitable to limit and/or prevent reverse translation of tape section 110.

As mentioned above guide body 101 may further include tape guide member 106. In general, tape guide member 106 may be formed in a first side of tape guide member 106, and may be configured to facilitate the orientation and/or alignment of a tip (not illustrated) of tape section 110 with a corresponding slot 111 of a cable-tie formed in head section 109. In this regard tape guide member 106 may include tape opening 107. Similar to head opening 103, tape opening 107 may have a profile that matches or substantially matches a cross sectional profile of tape section 110 of a cable-tie and/or a tip (not shown) thereof. Thus for example where tape section 110 (and/or a tip thereof) has a rectangular or substantially rectangular profile, tape opening 107 may have a rectangular or substantially rectangular profile that is sized to permit (e.g., snug) passage of tape section 110 there-through. Of course, such a profile is for the sake of example only, and tape opening 107 may have any suitable geometry.

Tape opening 107 may extend through the body of tape guide 106. The size and shape of tape opening 107 on one side of the body of tape guide 106 may be the same or different from the size and shape of tape opening 107 on the other side of the body of tape guide 106. In some embodiments the size of tape opening 107 on one side of the body of tape guide 106 is larger than the size of tape opening 107 on the other side of tape guide 107. In such instances the shape of tape opening 107 on one side of the body of tape guide 106 may be the same or different as the shape of tape opening 107 on the other side of the body of tape guide 106. Without limitation, in some embodiments the shape of tape opening 107 on a first side of the body of tape guide 106 is the same as or substantially similar to the shape of tape opening 107 on a second side of the body of tape guide 106, and the size of tape opening 107 on the first side is larger than or substantially the same size as the size of tape opening 107 on the second side of the body of tape guide 106.

As further shown in FIGS. 1 and 2, tape guide member 106 includes a recessed region (not labeled) that may be formed about tape opening 107. Such recessed region may be defined by one or more inner walls 108. In the embodiment of FIGS. 1 and 2 tape guide member 106 is illustrated as including a recessed region defined by four inner walls 108, but it should be understood that any number of inner walls 108 may be used. For example tape guide section may include a recessed region that is defined by a single (i.e., one) inner wall 108, e.g., in instances where the recessed region has a circular, conical, spheroidal, etc. profile. Alternatively, tape guide member 106 may include a recessed region that is defined by a plurality of inner walls 108, wherein at least some of inner walls 108 intersect to produce a recessed region having a triangular, quadrilateral, pentagonal, hexagonal, octagonal, etc. and/or irregular cross sectional profile.

In any case, one or more of sidewalls 108 may be configured to provide a beveled or tapered surface that spans all or a portion of the distance between an outside wall of tape guide 106 to tape opening 107. This concept is illustrated more clearly in FIG. 2, which depicts two sidewalls 108 that provide a tapered transition (e.g., a funnel) towards tape opening 107. As may be appreciated, tapering one or more of sidewalls 108 in this manner may facilitate alignment of a tip of tape section 110 with slot 111 formed in head section 109 of a cable tie.

That is, a tip of tape section 110 may be inserted into head opening 103. All or a portion of the length of tape section 110 may then be drawn through head opening 103 until a side of head section 109 abuts sidewall 105 of guide body 101. At this point and as illustrated in FIGS. 1 and 2, slot 111 within head section 109 may be aligned or substantially aligned with tape opening 107 in tape guide member 106. The tip of tape section 110 may then be guided into tape opening 107. During such guiding the tip of tape section 110 may contact and urge against one or more of sidewalls 108 providing a tapered transition towards tape opening 107. As a result, the tip of tape section 110 may be guided by the tapered transition through tape opening 107 and through slot 111 in head section 109 of the cable tie.

Although the cable-tie guides described herein may be used independent of other components, such use is not required. Indeed the present disclosure envisions embodiments in which one or more cable-tie guides are integrally formed or otherwise coupled to a component. As may be appreciated this may be provide a quick and convenient mechanism for aligning the tip and head sections of a cable-tie, thus permitting rapid securing of the component to one or more objects.

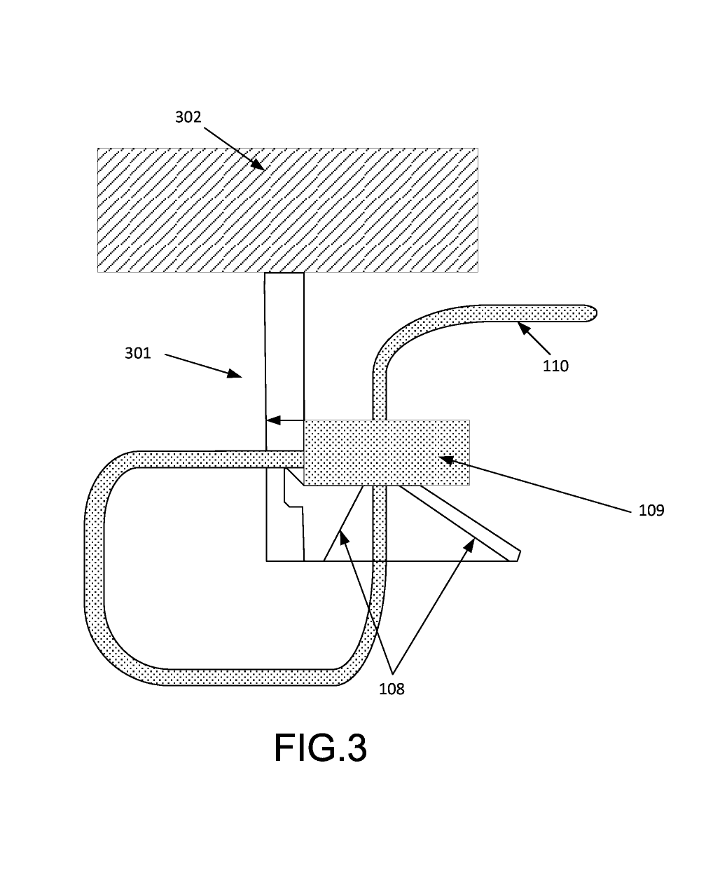

In this regard reference is made to FIG. 3, which depicts an embodiment in which a cable-tie guide 301 is integrally formed or otherwise coupled to component 302. Cable-tie guide 301 may be any cable-tie guide consistent with the present disclosure, such as but not limited to the embodiment shown in FIGS. 1 and 2. In any case, cable-tie guide 301 may in some embodiments be integrally formed with component 302. For example in instances where component 302 is manufactured by molding, extrusion, milling, etc., cable-tie guide 301 may be formed by the same or similar process such that it is integral with component 302, i.e., such that cable-tie guide 301 and component 302 are a single unitary piece.

In alternative embodiments, cable-tie guide 301 and component 302 may be manufactured as separate components, after which cable-tie guide may be coupled to component 301 in any suitable manner. By way of example, cable-tie guide 301 may be coupled to component 301 mechanically (e.g., by a fastener such as screw, a clamp, etc.), via an adhesive, by melt bonding, combinations thereof, and like.

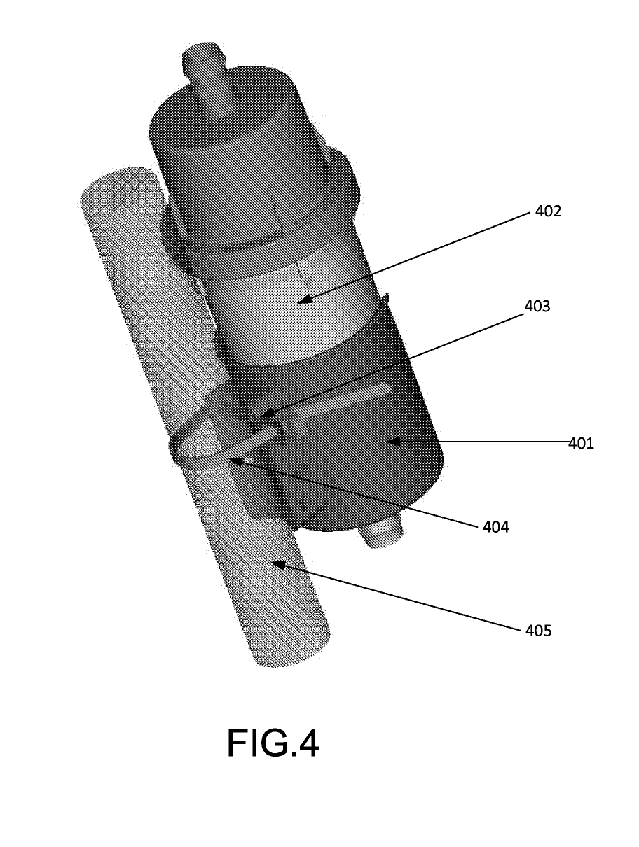

Component 302 may be any suitable component. In some embodiments, component 302 is a component of a machine, such as an automobile, motorcycle, boat, aircraft, and the like. Without limitation, component 302 is preferably a component of an automobile. Non-limiting examples of such components include holders for various automobile parts, such as but not limited to a holder for fuel system filter. In this regard reference is made to FIG. 4, which depicts a holder 401, e.g., for a fuel system filter (not shown). As shown, holder 401 includes a cable-tie guide 403, which may be integral with or otherwise coupled to holder 401. As further shown, cable-tie guide 403 may facilitate the orientation and coupling of the head and tip sections of cable tie 404, so as to define a loop that may be cinched around fuel system filter 402 so as to secure holder 401 (and fuel system filter 402) to support 405.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

What is claimed is:

1. A cable-tie guide, comprising a guide body, the guide body comprising a head guide member and a tape guide member, wherein:
said head guide comprises a head opening configured to permit passage of a tape section of a cable-tie there through and to prevent passage of a head section of said cable-tie there through; and
said tape guide member comprises first and second tape openings and a recessed region formed between the first and second tape openings, the recessed region comprising at least one sidewall providing a tapered transition between the first and second tape openings.

2. The cable-tie guide of claim 1, wherein when substantially all of said tape section of said cable-tie is pulled through said head opening, a slot in the head section of said cable-tie substantially aligns with said first tape opening in said tape guide member.

3. The cable-tie guide of claim 1, wherein said head guide has a profile that substantially matches a cross sectional profile of said tape section.

4. The cable-tie guide of claim 3, wherein said profile is substantially rectangular.

5. The cable-tie guide of claim 1, wherein said head opening comprises a first side and a second side, wherein:
the first and second sides are substantially parallel to one another; and
the first and second sides are oriented substantially perpendicular to a horizontal axis of said head guide.

6. The cable-tie guide of claim 1, wherein said head guide further comprises a retaining member configured to limit or prevent reverse translation of the tape section of said cable-tie once at least a portion of said tape section has been drawn through said head opening.

7. The cable-tie guide of claim 6, wherein said retaining member comprises a pawl configured to engage said cable-tie when at least a portion of said tape section has been drawn through said head opening.

8. The cable-tie guide of claim 1, wherein at least one of the first and second tape openings of said tape guide member has a profile that substantially matches a cross sectional profile of at least a portion of a tape section of said cable-tie.

9. The cable-tie guide of claim 8, wherein the profile of at least one of the first and second tape openings is substantially rectangular.

10. The cable-tie-guide of claim 1, wherein said first tape opening, said second tape opening, and said recessed region define a passage through said guide body for the tape section of said cable-tie.

11. The cable-tie guide of claim 1, wherein the first tape opening has a first profile and the second tape opening has a second profile, wherein the first and second profiles have the same or different geometry.

12. The cable-tie guide of claim 1, wherein the first tape opening is larger than the second tape opening.

13. The cable-tie guide of claim 1, wherein said recessed region is defined by at least one sidewall.

14. The cable-tie guide of claim 13, wherein said recessed region has a circular, conical, or spheroidal cross-sectional profile.

15. The cable-tie guide of claim 13, wherein said recessed region has a triangular, quadrilateral, pentagonal, hexagonal, octagonal, or irregular cross-sectional profile.

16. The cable-tie guide of claim 13, wherein at least one sidewall of said recessed region provides said tapered transition.

17. A component comprising a cable-tie guide coupled thereto, said cable tie guide comprising a guide body, the guide body comprising a head guide member and a tape guide member, wherein:
said head guide comprises a head opening configured to permit passage of a tape section of a cable-tie there through and to prevent passage of a head section of said cable-tie there through; and
said tape guide member comprises first and second tape openings and a recessed region formed between the first and second tape openings, the recessed region comprising at least one sidewall providing a tapered transition between the first and second tape openings.

18. The component of claim 17, wherein said cable tie-guide is integrally formed with said component, or is coupled to said component via a fastener, an adhesive, by melt bonding, or a combination thereof.

19. The component of claim 17, wherein said component is a component of a machine.

20. The component of claim 19, wherein said component is a holder for a fuel system filter of said machine.
